(19) United States
(12) Patent Application Publication
(10) Pub. No.: US 2026/0099911 A1
(43) Pub. Date: Apr. 9, 2026

(54) GAUGE READING METHOD AND GAUGE READING DEVICE

(71) Applicants: Hyundai Motor Company, Seoul (KR); Kia Corporation, Seoul (KR)

(72) Inventor: Sohee KIM, Hwaseong-Si (KR)

(73) Assignees: Hyundai Motor Company, Seoul (KR); Kia Corporation, Seoul (KR)

(21) Appl. No.: 19/324,530

(22) Filed: Sep. 10, 2025

(30) Foreign Application Priority Data
Oct. 8, 2024 (KR) 10-2024-0136329

(51) Int. Cl. G06T 7/00; G01D 7/00; G06T 7/60; G06T 7/80; G06V 10/24; G06V 10/82

(52) U.S. Cl. CPC G06T 7/0006; G01D 7/002; G06T 7/60; G06T 7/80; G06V 10/245; G06V 10/82

(57) ABSTRACT

In a gauge reading method and a gauge reading device for reading an analog gauge, the gauge reading method includes: acquiring a first image including an environment including a gauge; extracting a second image from the first image using an object detector, the second image corresponding to at least a partial portion of the first image and including the gauge; inferring a zero point, a gauge end point, a needle center point, and a needle end point from the second image using a deep neural network; obtaining a converted needle end point such that a depth difference between a gauge plate and a needle of the gauge is eliminated by reprojecting a location of the needle end point; determining an angle formed by a scale start point or a scale end point, the needle center point, and the converted needle end point; and converting the angle into a gauge value.

### CROSS-REFERENCE TO RELATED APPLICATION

This application claims priority to and the benefit of Korean Patent Application No. 10-2024-0136329 filed in the Korean Intellectual Property Office on Oct. 8, 2024, the entire contents of which are incorporated herein by reference.

### BACKGROUND

### Technical Field

The present disclosure relates to a gauge reading method and a gauge reading device, and more particularly, to a gauge reading method and a gauge reading device for reading an analog gauge through a maintenance robot.

### Description of the Related Art

The introduction of smart factories is greatly improving efficiency and productivity across the manufacturing industry. In a smart factory environment, the use of maintenance robots is essential to monitor factory status in real time and perform maintenance efficiently. Meanwhile, analog gauges are still widely used rather than digital gauges in smart factories, and reading analog gauges is a challenge in automated systems.

To solve the analog gauge reading issue, research has been conducted on methods for automatically reading gauge values. However, due to the structural characteristics of analog gauges, there are still several limitations in extracting accurate values. In particular, there is a space between a gauge needle and a plate, which may cause errors in values depending on the viewpoint, making it difficult to accurately estimate the values. In addition, a gauge is small among maintenance items, and it is more difficult for the robot to accurately estimate gauge values in an environment where there are an obstacle such as a fence. To solve these problems, it is necessary to develop more precise gauge reading technologies, and particularly, a new approach that takes into account the structural characteristics of analog gauges and the complexity of smart factory environments is required.

### SUMMARY

The present disclosure attempts to provide a gauge reading method and a gauge reading device capable of more accurately reading a value of an analog gauge in a smart factory.

An embodiment of the present disclosure provides a gauge reading method for reading an analog gauge through a maintenance robot, the gauge reading method including: acquiring a first image including an environment including a gauge; extracting a second image from the first image using an object detector, the second image corresponding to at least a partial portion of the first image and including the gauge; inferring a zero point, a gauge end point, a needle center point, and a needle end point from the second image using a deep neural network; obtaining a converted needle end point such that a depth difference between a gauge plate and a needle of the gauge is eliminated by reprojecting a location of the needle end point; determining an angle formed by a scale start point or a scale end point, the needle center point, and the converted needle end point; and converting the angle into a gauge value.

In some embodiments, two or more markers may be disposed around the gauge in the first image, and the extracting of the second image may include: extracting the second image from the first image, the second image corresponding to at least a partial portion of the first image and including the gauge and the two or more markers.

In some embodiments, each of the two or more markers may have a square shape, and include a binary pattern including black and white colors.

In some embodiments, the obtaining of the converted needle end point may include: determining a camera intrinsic matrix; determining a camera extrinsic matrix based on the camera intrinsic matrix; and performing three-dimension point reconstruction based on the camera extrinsic matrix.

In some embodiments, the determining of the camera intrinsic matrix may include: determining the camera intrinsic matrix by estimating camera intrinsic parameters through camera calibration.

In some embodiments, the determining of the camera extrinsic matrix may include: obtaining real coordinates in a three-dimensional space for vertices of the two or more markers disposed around the gauge; obtaining projection coordinates on a projection image for the vertices of the two or more markers; and determining the camera extrinsic matrix using the real coordinates, the projection coordinates, and the camera intrinsic matrix.

In some embodiments, the performing of the three-dimension point reconstruction may include: obtaining the camera extrinsic matrix, an estimated location of the needle of the gauge on the projection image, and a real distance from the gauge plate to the needle; obtaining an inverse function of a projection matrix; obtaining three-dimensional coordinates of the needle by inputting the estimated location of the needle into the projection matrix; and obtaining final coordinates by adjusting the obtained three-dimensional coordinates of the needle.

In some embodiments, the gauge reading method may further include: defining a vertical line extending perpendicular to a horizontal side of the second image while passing through the needle center point; determining a relative positional relationship by comparing coordinates of the needle center point and the needle end point in the second image; determining a first angle formed by a first intersection point where the vertical line intersects a lower horizontal side of the second image, the needle center point, and the needle end point when it is determined that the needle end point is located to the left of the needle center point; and converting the first angle into the gauge value.

In some embodiments, the gauge reading method may further include: determining a second angle formed by a second intersection point where the vertical line intersects an upper horizontal side of the second image, the needle center point, and the needle end point when it is determined that the needle end point is located to the right of the needle center point; and converting the second angle into the gauge value.

Another embodiment of the present disclosure provides a gauge reading method for reading an analog gauge through a maintenance robot, the gauge reading method including: acquiring a first image including an environment including a gauge; extracting a second image from the first image using an object detector, the second image corresponding to at least a partial portion of the first image and including the gauge; inferring a zero point, a gauge end point, a needle center point, and a needle end point from the second image using a deep neural network; reading an operation mode set in the maintenance robot; when the operation mode is set to a first operation mode, obtaining a converted needle end point such that a depth difference between a gauge plate and a needle of the gauge is eliminated by reprojecting a location of the needle end point, and when the operation mode is set to a second operation mode, determining an angle based on the converted needle end point; determining an angle based on a vertical line defined to extend perpendicular to a horizontal side of the second image while passing through the needle center point; and converting the angle into a gauge value.

In some embodiments, the gauge reading method may further include: evaluating a quality of the second image; setting the operation mode to the first operation mode when the quality of the second image is evaluated to be higher than or equal to a predetermined criterion; and setting the operation mode to the second operation mode when the quality of the second image is evaluated to be lower than the predetermined criterion.

In some embodiments, the determining of the angle based on the converted needle end point may include: determining an angle formed by a scale start point or a scale end point, the needle center point, and the converted needle end point.

In some embodiments, the determining of the angle based on the converted needle end point may include: determining a camera intrinsic matrix; determining a camera extrinsic matrix based on the camera intrinsic matrix; and performing three-dimension point reconstruction based on the camera extrinsic matrix.

In some embodiments, the determining of the angle based on the vertical line may include: determining a relative positional relationship by comparing coordinates of the needle center point and the needle end point in the second image; and determining, as the angle, a first angle formed by a first intersection point where the vertical line intersects a lower horizontal side of the second image, the needle center point, and the needle end point when it is determined that the needle end point is located to the left of the needle center point.

In some embodiments, the determining of the angle based on the vertical line may include: determining, as the angle, a second angle formed by a second intersection point where the vertical line intersects an upper horizontal side of the second image, the needle center point, and the needle end point when it is determined that the needle end point is located to the right of the needle center point.

Another embodiment of the present disclosure provides a gauge reading device for reading an analog gauge through a maintenance robot, the device including: one or more memory devices configured to store instructions; and one or more processors configured to execute the instructions to perform operations, the operations comprising: acquiring a first image including an environment including a gauge; extracting a second image from the first image using an object detector, the second image corresponding to at least a partial portion of the first image and including the gauge; inferring a zero point, a gauge end point, a needle center point, and a needle end point from the second image using a deep neural network; obtaining a converted needle end point such that a depth difference between a gauge plate and a needle of the gauge is eliminated by reprojecting a location of the needle end point; determining an angle formed by a scale start point or a scale end point, the needle center point, and the converted needle end point; and converting the angle into a gauge value.

In some embodiments, two or more markers may be disposed around the gauge in the first image, and the extracting of the second image may include: extracting the second image from the first image, the second image corresponding to at least a partial portion of the first image and including the gauge and the two or more markers.

In some embodiments, the obtaining of the converted needle end point may include: determining a camera intrinsic matrix; determining a camera extrinsic matrix based on the camera intrinsic matrix; and performing three-dimension point reconstruction based on the camera extrinsic matrix.

In some embodiments, the operations may further include: defining a vertical line extending perpendicular to a horizontal side of the second image while passing through the needle center point; determining a relative positional relationship by comparing coordinates of the needle center point and the needle end point in the second image; determining a first angle formed by a first intersection point where the vertical line intersects a lower horizontal side of the second image, the needle center point, and the needle end point when it is determined that the needle end point is located to the left of the needle center point; and converting the first angle into the gauge value.

In some embodiments, the operations may further include: determining a second angle formed by a second intersection point where the vertical line intersects an upper horizontal side of the second image, the needle center point, and the needle end point when it is determined that the needle end point is located to the right of the needle center point; and converting the second angle into the gauge value.

### BRIEF DESCRIPTION OF THE DRAWINGS

FIG. 1 is a diagram for explaining a gauge reading device according to an exemplary embodiment.

FIG. 2 is a diagram for explaining a gauge reading method according to an exemplary embodiment.

FIG. 3, FIG. 4, FIG. 5, FIG. 6, and FIG. 7 are diagram for explaining gauge reading implementation examples according to embodiments.

FIG. 8 is a diagram for explaining a gauge reading method according to an exemplary embodiment.

FIG. 9 and FIG. 10 are diagrams for explaining gauge reading implementation examples according to embodiments.

FIG. 11 is a diagram for explaining a gauge reading method according to an exemplary embodiment.

FIG. 12 is a diagram for explaining a computing device according to an exemplary embodiment.

### DETAILED DESCRIPTION

Hereinafter, exemplary embodiments of the present disclosure will be described in detail with reference to the accompanying drawings, so that they can be easily carried out by those having ordinary knowledge in the art to which the present disclosure pertains. However, the present disclosure may be implemented in various different forms, and is not limited to the embodiments described herein. In order to clearly explain the present disclosure, parts irrelevant to the description will be omitted from the drawings, and like elements will be denoted by like reference numerals throughout the specification.

Throughout the specification and the claims, when a certain part is referred to as “including” a certain component, this implies the presence of other components, not precluding the presence of other components, unless explicitly stated to the contrary. Terms including ordinal numbers such as “first” and “second” may be used to describe various components, but these components are not limited by such terms. Such terms are used only for the purpose of distinguishing one component from another component.

Furthermore, the terms “unit”, “-er(or)”, “module”, and the like used herein may refer to a unit capable of performing at least one function or operation described herein, which may be implemented by hardware or circuitry, software, or a combination of hardware or circuitry and software. Additionally, at least some of the configurations or functions of the gauge reading methods and gauge reading devices according to the embodiments to be described below may be implemented by programs or software, and the programs or software may be stored in a computer-readable medium.

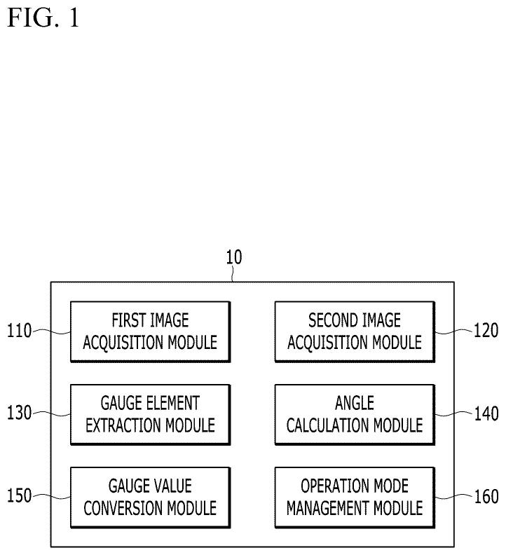

FIG. 1 is a diagram for explaining a gauge reading device according to an embodiment.

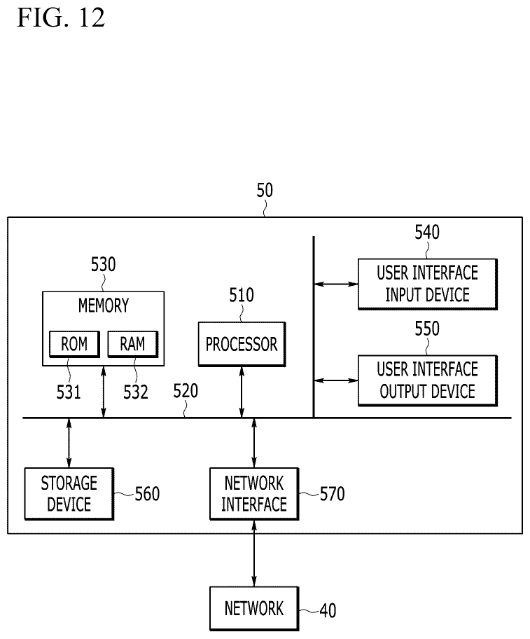

Referring to FIG. 1, a gauge reading device 10 according to an embodiment may execute program codes or instructions loaded on one or more memory devices through one or more processors. For example, the gauge reading device 10 may be implemented as a computing device 50 as will be described below with respect to FIG. 12. In this case, the one or more processors may correspond to a processor 510 of the computing device 50, and the one or more memory devices may correspond to a memory 520 of the computing device 50. The program codes or instructions may be executed by the one or more processors to perform an analog gauge reading function via a maintenance robot. In order to logically distinguishing the functions performed by the program codes or instructions, the term “module” is used herein.

The gauge reading device 10 according to an embodiment may include a first image acquisition module 110, a second image acquisition module 120, a gauge element extraction module 130, an angle calculation module 140, a gauge value conversion module 150, and an operation mode management module 160.

The first image acquisition module 110 may acquire a first image including an environment including a gauge. For example, the first image acquisition module 110 may acquire a first image including the interior of a smart factory including a gauge or a facility of a smart factory including a gauge. In some embodiments, the first image acquisition module 110 may include a camera fixed inside the smart factory to capture images, or mounted on the maintenance robot to capture images from various angles while moving around.

The second image acquisition module 120 may extract a second image corresponding to at least a partial portion of the first image and including the gauge from the first image acquired by the first image acquisition module 110 using an object detector. In some embodiments, the second image acquisition module 120 may extract the second image from the first image using a you only look once (YOLO) detection network. The YOLO detection network is a deep learning-based network designed for real-time object detection, and is capable of quickly and accurately detecting objects in images by processing the images in a single pass. Here, the YOLO network or YOLO model may learn locations and shapes of gauges from a dataset labeled with locations and types of gauges collected for various types of analog gauge images used in a smart factory. The second image acquisition module 120 may input image data input in real time from a smart factory into the YOLO model, and the YOLO model may process the image in a single pass to detect a location of a gauge and the type of the gauge and display the location as a bounding box. It is needless to say that the second image acquisition module 120 may extract the second image from the first image using various object detectors, including a region-based convolutional neural network (Faster R-CNN), a single shot multibox detector (SSD), and RetinaNet, not limited to the YOLO detection network.

In some embodiments, two or more markers may be disposed around the gauge in the first image. In some embodiments, the marker may have a square shape and include a binary pattern including black and white colors. Each of the markers is given a unique ID, so that the marker can be easily identified using the unique ID, and a specific marker can be accurately tracked even in an environment with the multiple markers. The marker has a grid-like pattern consisting of square black and white cells, enabling a computer vision algorithm to easily recognize the location and direction or the marker through the pattern of the marker. The second image acquisition module 120 may extract, from the first image, a second image corresponding to at least a partial portion of the first image and including a gauge and two or more markers.

The gauge element extraction module 130 may infer a zero point, a gauge end point, a needle center point, and a needle end point from the second image acquired by the second image acquisition module 120 using a deep neural network. Here, the zero point, the gauge end point, the needle center point, and the needle end point may be treated as components of the gauge.

In some embodiments, the gauge element extraction module 130 may infer a zero point, a gauge end point, a needle center point, and a needle end point from the second image using a deep neural network having a structure including an encoder and a decoder, i.e., an encoder-decoder structure. A model having the encoder-decoder structure may be a model that performs a process of converting input data into a compressed representation and restoring the compressed representation back to the original data format. Specifically, the encoder receives input data, and converts the high-dimensional input data into a low-dimensional latent representation. In this process, important features may be extracted from the input data and unnecessary information may be removed from the input data. The encoder may consist of a plurality of neural network layers, and the layers may gradually compress data to finally generate a compressed representation called a latent vector or a latent space. The decoder may receive the latent vector generated by the encoder and restore the latent vector to the original data format or convert the latent vector to a target output format. The decoder may also consist of a plurality of neural network layers, and may decode the latent vector by performing the inverse process of the encoder to implement reconstruction or prediction of the input data.

For example, the latent vector generated in the last layer of the encoder may contain information about a zero point, a gauge end point, a needle center point, and a needle end point, which summarizes important information of the second image. The latent vector implicitly represents the complex pattern of the second image data in a compressed state through the encoder, making it possible to effectively reflect exact locations and characteristics of gauge elements. Thereafter, the decoder may receive the latent vector and expand the latent vector into a high-dimensional space to restore the latent vector to the original image format or generate a segmented output. The decoder may decode the information contained in the latent vector by performing the inverse process of the encoder to reconstruct the respective locations and forms of the gauge elements. For example, the decoder may gradually expand the compressed representation through multiple deconvolution layers to restore detailed elements of the gauge and derive accurate coordinate information, and finally generate an output map including coordinates of the zero point, the gauge end point, the needle center point, and the needle end point in the second image.

In some embodiments, the encoder may be implemented based on Residual Network (ResNet), MobileNet, and the like. ResNet, which is designed to solve learning difficulties that may occur as the depth of the deep learning model increases, introduces a unique structure called residual connection, so that learning performance can be maintained or rather improved even if the neural network becomes deeper. In addition, the residual connection may play a significant role in alleviating the vanishing gradient problem during the learning of the neural network by passing the input data from intermediate layers back to the output. ResNet may be implemented in versions with various depths, and is particularly suitable for the role of the encoder that needs to recognize a complex pattern because it excels in image recognition and classification tasks that require deep neural networks. MobileNet is a lightweight deep learning model designed for use in environments with limited computational resources such as mobile devices or embedded systems, and achieves the reduction in model weight without degradation of performance by applying filters separately using depthwise separable convolution and then combining results together. MobileNet may be used as an encoder, especially in applications where real-time processing performance is important, and can maintain high accuracy even in resource-constrained environments.

In some embodiments, the decoder may be implemented based on deconvolution, upsampling, and convolution layers. Deconvolution may be used to restore the input feature map to its original resolution, and may operate in such a manner as to expand the size of the feature map while maintaining the spatial pattern of the input data through the inverse process of convolution. For example, the deconvolution may be useful for image generation or restoration tasks, as it is capable of generating new pixels based on patterns learned from the previous layers, while converting a small-sized feature map into a large- sized one. The upsampling may be used to increase the resolution of the input feature map, and may be advantageous in applications such as real-time processing because it operates in a simple way and requires a small computational amount. The convolutional layers may be used by the decoder after the deconvolution or upsampling process to refine the feature map and restore the fine pattern. For example, the convolutional layers may learn interactions between pixels while maintaining the resolution of the feature map to improve the texture of the output image and restore details of the input image or remove noise.

After a zero point, a gauge end point, a needle center point, and a needle end point are inferred from the second image, the gauge element extraction module 130 may reproject a location of the needle end point into a three-dimensional space to obtain a needle end point converted to eliminate a depth difference between a gauge plate and a needle.

Specifically, the gauge element extraction module 130 may first determine a camera intrinsic matrix to obtain a converted needle end point. In some embodiments, the gauge element extraction module 130 may determine a camera intrinsic matrix by estimating camera intrinsic parameters through camera calibration. For example, the gauge element extraction module 130 may collect checkerboard images captured from various angles. The checkerboard image has a square grid pattern, and may be used to determine camera intrinsic parameters based on the intersections between grids. During the calibration process, the gauge element extraction module 130 may derive elements constituting the camera internal matrix by analyzing a relationship between intersection coordinates in the checkerboard and real coordinates. For example, the gauge element extraction module 130 may determine a camera internal matrix including parameters such as a focal length, an optical center, and a distortion coefficient of the camera based on input checkerboard image data.

Next, the gauge element extraction module 130 may determine a camera extrinsic matrix based on the camera intrinsic matrix. In some embodiments, the gauge element extraction module 130 may obtain real coordinates in a three-dimensional space for vertices of the markers disposed around the gauge, obtain projection coordinates on a projection image for the vertices of the markers, and determine a camera extrinsic matrix using the real coordinates, the projection coordinates, and the camera intrinsic matrix.

Next, the gauge element extraction module 130 may perform three-dimension point reconstruction based on the camera extrinsic matrix. In some embodiments, the gauge element extraction module 130 may obtain the camera extrinsic matrix, an estimated location of the needle of the gauge on the projection image, and a real distance from the gauge plate to the needle, obtain an inverse function of a projection matrix, obtain three-dimensional coordinates of the needle by inputting the estimated location of the needle into the projection matrix, and obtain final coordinates by adjusting the obtained three-dimensional coordinates of the needle.

The angle calculation module 140 may determine an angle formed by a scale start point or a scale end point, a needle center point extracted by the gauge element extraction module 130, and a needle end point converted by the gauge element extraction module 130.

The gauge value conversion module 150 may convert the angle into a gauge value.

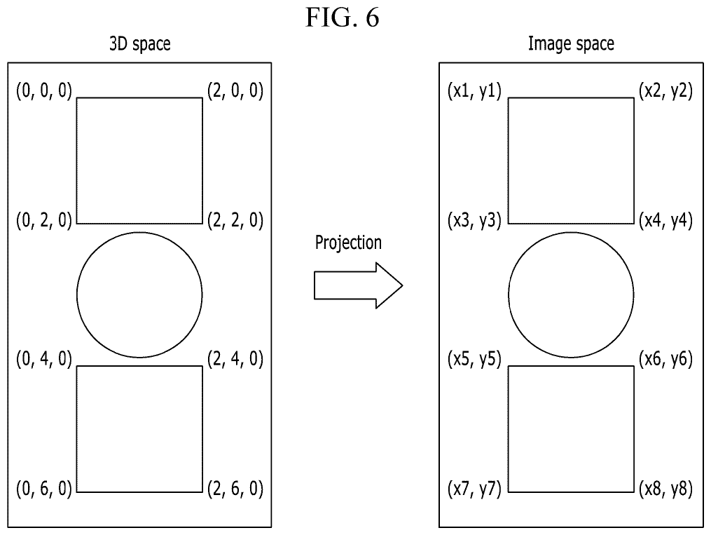

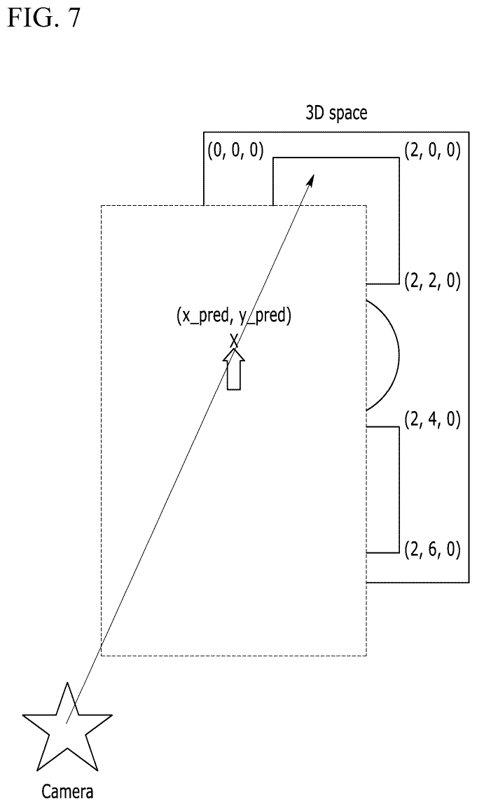

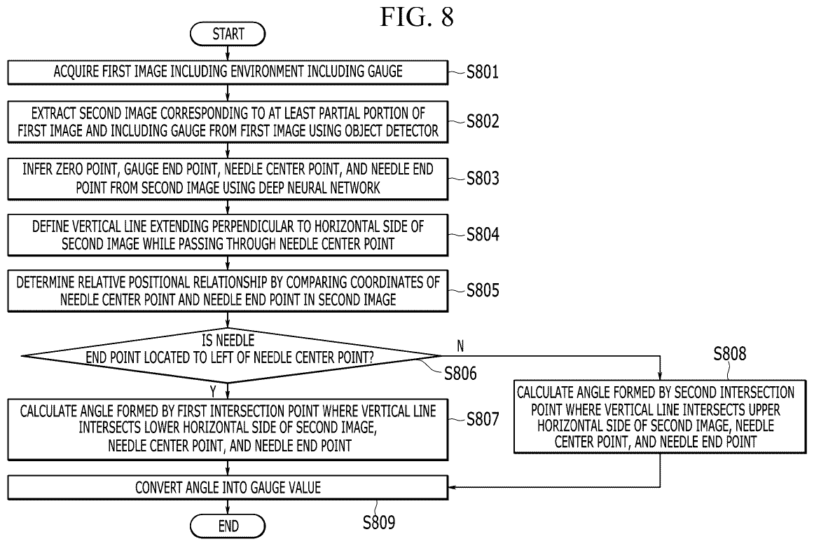

The operation mode management module 160 may read the operation mode set in the maintenance robot. When the operation mode set in the maintenance robot is a first operation mode, the operation mode management module 160 may allow the angle calculation module 140 to operate in a precise gauge inference mode to be described with reference to FIGS. 1 to 7. On the other hand, when the operation mode set in the maintenance robot is a second operation mode, the operation mode management module 160 may allow the angle calculation module 140 to operate in a rough gauge inference mode to be described with reference to FIGS. 8 to 10.

In some embodiments, the operation mode management module 160 may evaluate a quality of the second image. When the quality of the second image is evaluated to be higher than or equal to a predetermined criterion, the operation mode is set to the first operation mode, and when the quality of the second image is evaluated to be lower than the predetermined criterion, the operation mode is set to the second operation mode. Accordingly, as a result of evaluating the quality of the second image, when the quality of the image including the gauge is not poor or the gauge is not hidden by an obstacle, the angle calculation module 140 may perform precise gauge inference according to the first operation mode, and when the quality of the image including the gauge is poor or the gauge is hidden by an obstacle, the angle calculation module 140 may perform rough gauge inference according to the second operation mode.

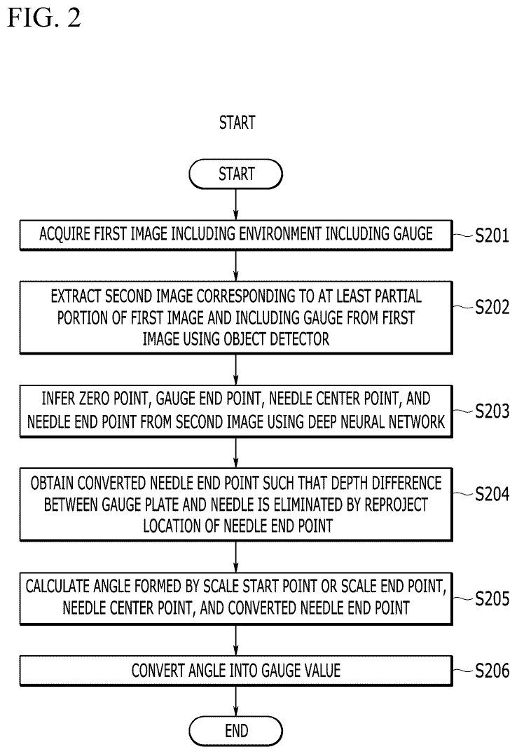

FIG. 2 is a diagram for explaining a gauge reading method according to an embodiment.

Referring to FIG. 2, the gauge reading method according to an embodiment may include acquiring a first image including an environment including a gauge (S201), extracting a second image corresponding to at least a partial portion of the first image and including the gauge from the first image using an object detector (S202), inferring a zero point, a gauge end point, a needle center point, and a needle end point from the second image using a deep neural network (S203), obtaining a converted needle end point such that a depth difference between a gauge plate and a needle of the gauge is eliminated by reprojecting a location of the needle end point (S204), determining an angle formed by a scale start point or a scale end point, the needle center point, and the converted needle end point (S205), and converting the angle into a gauge value (S206).

For further details of the above-described method, the description of embodiments described herein may be referred to, and thus, redundant description is omitted here.

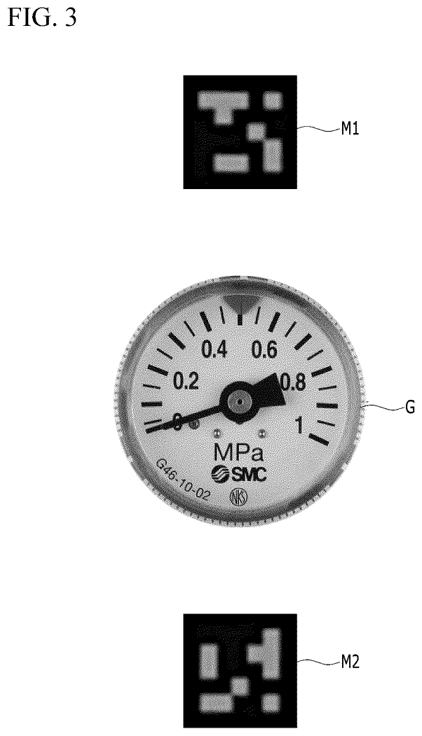

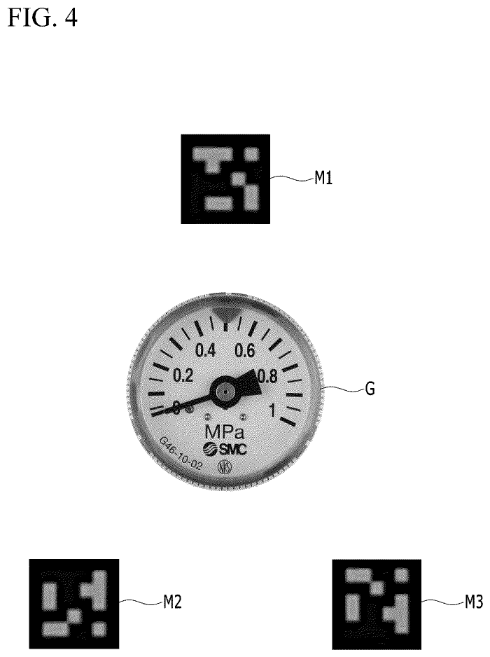

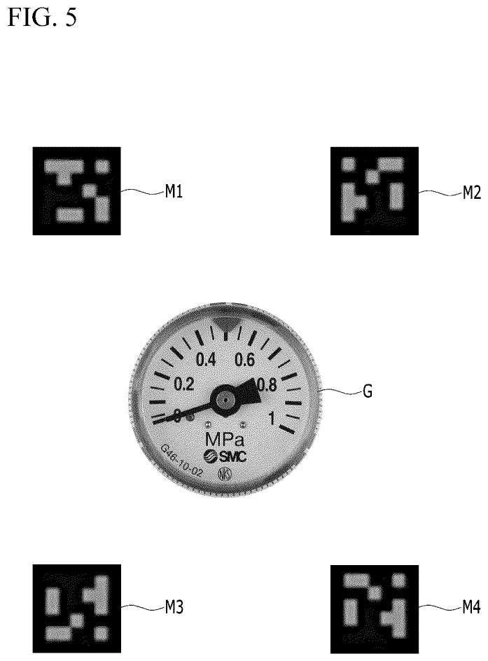

FIGS. 3 to 7 are diagram for explaining gauge reading implementation examples according to embodiments.

Referring to FIG. 3, in which it is illustrated that two markers M1 and M2 are disposed around a gauge G, the first image acquisition module 110 may acquire a first image including an environment including the gauge G, and the second image acquisition module 120 may extract a second image from the first image using an object detector, the second image corresponding to at least a partial portion of the first image and including the gauge G and the two markers M1 and M2. Thereafter, the gauge element extraction module 130 may infer a zero point, a gauge end point, a needle center point, and a needle end point from the second image.

Referring to FIG. 4, in which it is illustrated that three markers M1, M2, and M3 are disposed around a gauge G, the first image acquisition module 110 may acquire a first image including an environment including the gauge G, and the second image acquisition module 120 may extract a second image from the first image using an object detector, the second image corresponding to at least a partial portion of the first image and including the gauge G and the three markers M1, M2, and M3. Thereafter, the gauge element extraction module 130 may infer a zero point, a gauge end point, a needle center point, and a needle end point from the second image.

Referring to FIG. 5, in which it is illustrated that four markers M1, M2, M3, and M4 are disposed around a gauge G, the first image acquisition module 110 may acquire a first image including an environment including the gauge G, and the second image acquisition module 120 may extract a second image from the first image using an object detector, the second image corresponding to at least a partial portion of the first image and including the gauge G and the four markers M1, M2, M3, and M4. Thereafter, the gauge element extraction module 130 may infer a zero point, a gauge end point, a needle center point, and a needle end point from the second image.

Referring to FIG. 6, the gauge element extraction module 130 may obtain real coordinates in a three-dimensional space for vertices of the markers disposed around the gauge, obtain projection coordinates on a projection image for the vertices of the markers, and determine a camera extrinsic matrix using the real coordinates, the projection coordinates, and a camera intrinsic matrix. As illustrated in FIG. 6, the gauge element extraction module 130 may obtain (0, 0, 0), (2, 0, 0), (0, 2, 0), and (2, 2, 0) as real coordinates in the three-dimensional space of the marker disposed above the gauge, and obtain (0, 4, 0), (2, 4, 0), (0, 6, 0), and (2, 6, 0) as real coordinates in the three-dimensional space of the marker disposed below the gauge. In the three-dimensional space, the depth is set to 0. Meanwhile, the gauge element extraction module 130 may obtain (x1, y1), (x2, y2), (x3, y3), and (x4, y4) as projection coordinates on the projection image of the marker disposed above the gauge, and may obtain (x5, y5), (x6, y6), (x7, y7), and (x8, y8) as projection coordinates on the projection image of the marker disposed below the gauge. The gauge element extraction module 130 may determine a camera extrinsic matrix using the real coordinates (0, 0, 0), (2, 0, 0), (0, 2, 0), and (2, 2, 0) of the marker disposed above the gauge, the real coordinates (0, 4, 0), (2, 4, 0), (0, 6, 0), and (2, 6, 0) of the marker disposed below the gauge, the projection coordinates (x1, y1), (x2, y2), (x3, y3), and (x4, y4) of the marker disposed above the gauge, the projection coordinates (x5, y5), (x6, y6), (x7, y7), and (x8, y8) of the marker disposed below the gauge, and the camera intrinsic matrix, which a camera calibration result.

That is, the camera extrinsic matrix may represent a location and a direction of the camera, and the gauge element extraction module 130 may estimate a relationship between the real coordinates of the markers in the three-dimensional space and the corresponding coordinates on the two-dimensional image. When the real coordinates of the eight corners of the markers (the coordinates in the three-dimensional space) and the coordinates of the eight corners on the image (the two-dimensional coordinates) are given, they have a correspondence relationship, and the gauge element extraction module 130 may determine a location and a direction of the camera using their correspondence relationship. In some embodiments, the gauge element extraction module 130 may estimate an initial extrinsic matrix by performing random sampling multiple times based on the given data, apply corresponding matrices to the remaining coordinates (pairs of corresponding three-dimensional and two-dimensional coordinates) using the estimated initial extrinsic matrix to repeat a process of evaluating how well the matrix fits the model, and determine a matrix including data capable of explaining the model best as a final camera extrinsic matrix.

Referring to FIG. 7, the gauge element extraction module 130 may perform three-dimension point reconstruction based on the camera extrinsic matrix. As illustrated in FIG. 7, the camera extrinsic matrix, the estimated coordinates (x_{pred}, y_{pred}) of the gauge needle on the image, and the real distance from the gauge plate to the needle (z/c=0.5) are already known values. Based on this information, a three-dimensional coordinate value of the gauge needle may be determined by using the inverse function of the projection matrix from 2D to 3D. In this process, since the initially estimated z value may not be an accurate value, the known value of the real depth from the gauge plate to the gauge needle is substituted into z to obtain a more accurate real three-dimensional coordinate value. For example, when the converted three-dimensional coordinate value of the needle is (2, 4, 6) and the value of the real depth from the gauge plate to the needle is 3 cm, then c=2 is determined from 6/c=3, and all the coordinates are divided by this value, thereby finally obtaining a three-dimensional coordinate value of (1, 2, 3).

In this regard, the following formulas may be referred to.

$$I \times E = P ( 3 D \to 2 D )$$

Here, I may be a camera intrinsic matrix, E may be a camera extrinsic matrix, and P may be a projection matrix. The above formula may indicate mapping of three-dimensional coordinates to two-dimensional coordinates.

$$\begin{matrix}{P}^{- 1} ( \begin{matrix}{x}_{pred} \\ {y}_{pred} \\ 1\end{matrix} ) = ( \begin{matrix}a \\ b \\ z \\ 1\end{matrix} ) \\ z / c = d \\ c = z / d \\ FINAL X = az / d \\ FINAL Y = bz / d\end{matrix}$$

Here, a may represent a three-dimensional x coordinate value estimated from x_{pred} without considering the real depth, b may represent a three-dimensional y coordinate value estimated from y_{pred} without considering the real depth, z may represent an estimated depth value, c may represent a focal length, d may represent a real depth value, that is, a value of a real depth from the gauge plate to the needle, “FINAL X” may represent a final x coordinate value, and “FINAL Y” may represent a final y coordinate value.

While the embodiments described above with reference to FIGS. 1 to 7 correspond to precise gauge inference, exemplary embodiments to be described with reference to FIGS. 8 to 10 may correspond to rough gauge inference. The rough gauge inference may be used together with the precise gauge inference to handle situations where the image containing the gauge is of poor quality or is obscured by an obstacle.

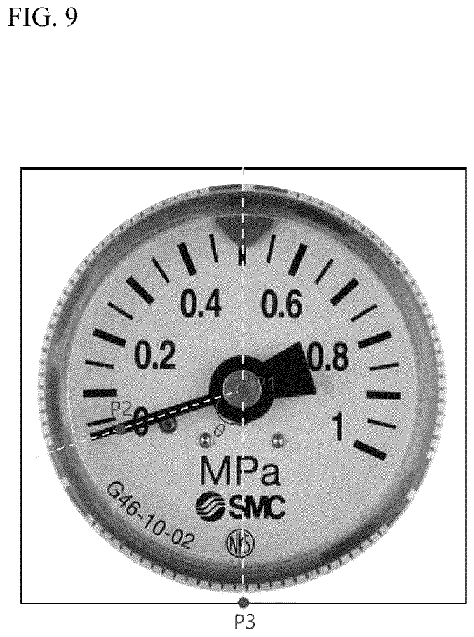

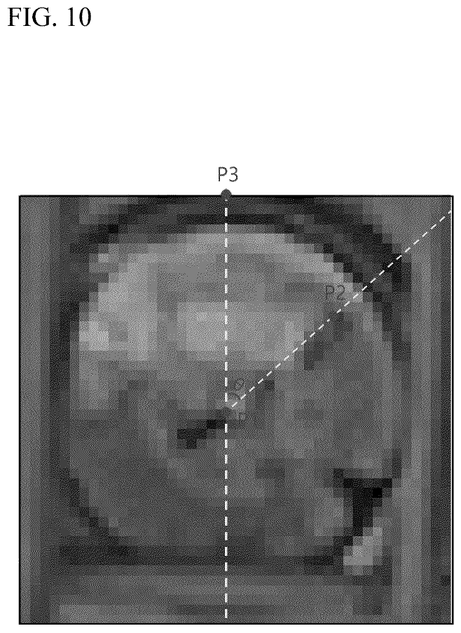

FIG. 8 is a diagram for explaining a gauge reading method according to an embodiment, and FIGS. 9 and 10 are diagrams for explaining gauge reading implementation examples according to embodiments.

Referring to FIG. 8, the gauge reading method according to an embodiment may include acquiring a first image including an environment including a gauge by the first image acquisition module 110 (S801), extracting a second image corresponding to at least a partial portion of the first image and including the gauge from the first image using an object detector by the second image acquisition module 120 (S802), inferring a zero point, a gauge end point, a needle center point, and a needle end point from the second image using a deep neural network by the gauge element extraction module 130 (S803), and defining a vertical line extending perpendicular to a horizontal side of the second image while passing through the needle center point by the angle calculation module 140 (S804). For steps S801 to S804, the description of embodiments described above with reference to FIGS. 1 to 7 may be referred to, and thus, redundant description is omitted here.

In addition, the gauge reading method may include determining a relative positional relationship by comparing coordinates of the needle center point and the needle end point in the second image by the angle calculation module 140 (S805), and determining whether the needle end point is located to the left of the needle center point by the angle calculation module 140 (S806).

When it is determined that the needle end point is located to the left of the needle center point (S806, ‘Y’), the gauge reading method may include determining an angle formed by a first intersection point where the vertical line intersects a lower horizontal side of the second image, the needle center point, and the needle end point by the angle calculation module 140 (S807), and converting the angle into a gauge value by the gauge value conversion module 150 (S809).

When it is determined that the needle end point is not located to the left of the needle center point (S806, ‘N’), the gauge reading method may include determining an angle formed by a second intersection point where the vertical line intersects an upper horizontal side of the second image, the needle center point, and the needle end point by the angle calculation module 140 (S808), and converting the angle into a gauge value by the gauge value conversion module 150 (S809).

Referring to FIG. 9 together, the angle calculation module 140 may define a vertical line extending perpendicular to a horizontal side of the second image while passing through a needle center point P1, determine a relative positional relationship by comparing coordinates of the needle center point PI and a needle end point P2 in the second image, and determine a first angle formed by a first intersection point P3 where the vertical line intersects a lower horizontal side of the second image, the needle center point P1, and the needle end point P2 when it is determined that the needle end point P2 is located to the left of the needle center point P1, and the gauge value conversion module 150 may convert the first angle into a gauge value.

Referring to FIG. 10 together, when it is determined that the needle end point P2 is located to the right of the needle center point P1, a second angle may be determined, the second angle being formed by a second intersection point P3 where the vertical line intersects the upper horizontal side of the second image, the needle center point P1, and the needle end point P2, and the gauge value conversion module 150 may convert the second angle into a gauge value.

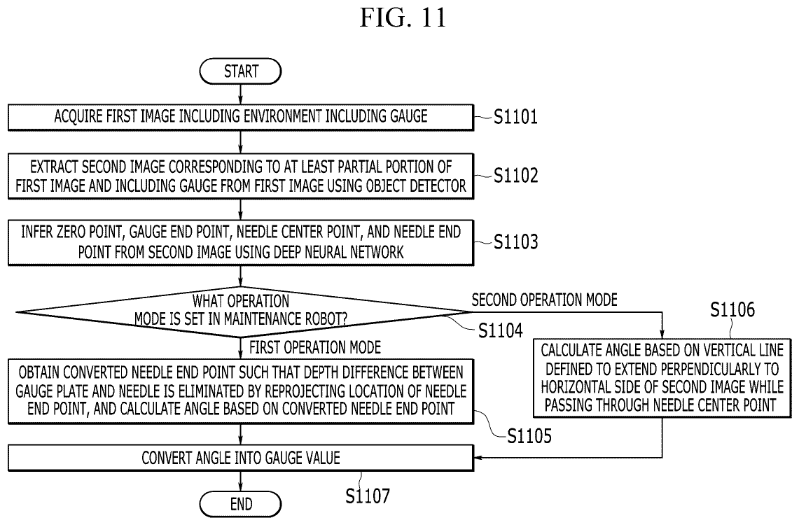

FIG. 11 is a diagram for explaining a gauge reading method according to an embodiment.

Referring to FIG. 11, the gauge reading method according to an embodiment may include acquiring a first image including an environment including a gauge by the first image acquisition module 110 (S1101), extracting a second image corresponding to at least a partial portion of the first image and including the gauge from the first image using an object detector by the second image acquisition module 120 (S1102), and inferring a zero point, a gauge end point, a needle center point, and a needle end point from the second image using a deep neural network by the gauge element extraction module 130 (S1103). For steps S1101 to S1103, the description of embodiments described above with reference to FIGS. 1 to 7 may be referred to, and thus, redundant description is omitted here.

In addition, the gauge reading method may include reading an operation mode set in the maintenance robot by the operation mode management module 160 (S1104).

When the operation mode set in the maintenance robot is determined to be the first operation mode (S1104, ‘first operation mode’), the gauge reading method may include obtaining a converted needle end point such that a depth difference between a gauge plate and a needle of the gauge is eliminated by reprojecting a location of the needle end point by the angle calculation module 140, and determining an angle based on the converted needle end point (S1105), and converting the angle into a gauge value by the gauge value conversion module 150 (S1107). That is, in the first operation mode, the precise gauge inference described above with reference to FIGS. 1 to 7 may be performed. For steps S1105 to S1107, the description of embodiments described above with reference to FIGS. 1 to 7 may be referred to, and thus, redundant description is omitted here.

When the operation mode set in the maintenance robot is determined to be the second operation mode (S1104, ‘second operation mode’), the gauge reading method may include determining an angle based on a vertical line defined to extend perpendicular to a horizontal side of the second image while passing through the needle center point by the angle calculation module 140 (S1106), and converting the angle into a gauge value by the gauge value conversion module 150 (S1107). That is, in the second operation mode, the rough gauge inference described above with reference to FIGS. 8 to 10 may be performed. For steps S1106 and S1107, the description of embodiments described above with reference to FIGS. 8 to 10 may be referred to, and thus, redundant description is omitted here.

In some embodiments, the gauge reading method may further include, by the operation mode management module 160, evaluating a quality of the second image, setting the operation mode to the first operation mode when the quality of the second image is evaluated to be higher than or equal to a predetermined criterion, and setting the operation mode to the second operation mode when the quality of the second image is evaluated to be lower than the predetermined criterion. Accordingly, as a result of evaluating the quality of the second image, when the quality of the image including the gauge is not poor or the gauge is not hidden by an obstacle, precise gauge inference may be performed according to the first operation mode, and when the quality of the image including the gauge is poor or the gauge is hidden by an obstacle, rough gauge inference may be performed according to the second operation mode.

FIG. 12 is a diagram for explaining a computing device according to an embodiment.

Referring to FIG. 12, the gauge reading methods and the gauge reading devices according to embodiments may be implemented using a computing device 50. The computing device 50 may be implemented as various forms of electronic devices, servers, or devices similar thereto, and its functions may be implemented through a combination of software and hardware.

The computing device 50 may include at least one of a processor 510, a memory 530, a user interface input device 540, a user interface output device 550, and a storage device 560 that communicate with each other via a bus 520. The computing device 50 may also include a network interface 570 electrically connected to a network 40. The network interface 570 may transmit or receive signals with other entities via the network 40.

The processor 510 may be implemented by various types of computing units, such as a micro controller unit (MCU), an application processor (AP), a central processing unit (CPU), a graphic processing unit (GPU), a neural processing unit (NPU), or a quantum processing unit (QPU). The processor 510 is also a semiconductor device that executes instructions stored in the memory 530 or the storage device 560, and may play a key role in the system. Program codes and data stored in the memory 530 or the storage device 560 instruct the processor 510 to perform specific tasks, thereby enabling the overall operation of the system. The processor 510 may be configured to implement the various functions and methods described above with respect to FIGS. 1 to 11.

The memory 530 and the storage device 560 may include various types of volatile or non-volatile storage media for storage of data in the system and access to data in the system. For example, the memory 530 may include a read-only memory (ROM) 531 and a random access memory (RAM) 532. In some embodiments, the memory 530 may be embedded in the processor 510, and in this case, data may be transferred between the memory 530 and the processor 510 at a very fast speed. In some other embodiments, the memory 530 may be located outside the processor 510, and in this case, the memory 530 may be connected to the processor 510 through various data buses or interfaces. This connection may be made through various already-known means, for example, a peripheral component interconnect express (PCIe) interface for high-speed data transfer or through a memory controller.

In some embodiments, at least some of the configurations or functions of the gauge reading methods and gauge reading devices according to the embodiments may be implemented by programs or software executed by the computing device 50, and the programs or software may be stored in a computer-readable medium. Specifically, the computer-readable medium according to an embodiment may be a program recorded for causing a computer including the processor 510 that executes the programs or instructions stored in the memory 530 or the storage device 560 to execute the steps included in implementing the gauge reading methods and the gauge reading devices according to embodiments.

In some embodiments, at least some of the configurations or functions of the gauge reading methods and gauge reading devices according to the embodiments may be implemented using hardware or circuitry of the computing device 50, or may be implemented by separate hardware or circuitry that may be electrically connected to the computing device 50.

According to embodiments, significant labor and time savings can be provided when maintenance items are inspected utilizing maintenance robots in smart factories. According to embodiments, by adopting the precision inference mode for the gauge, the depth difference between the gauge plate and the needle can be eliminated, thus inferring a gauge value that is robust to a change in viewpoint. In addition, according to embodiments, the status of the gauge can be effectively checked through the rough inference mode for the gauge even in an environment where there is an obstacle, enabling accurate inspection even in an environment that is difficult to handle with existing technologies. In addition, according to embodiments, the gauge recognition network has a simple configuration, making it possible to secure real-time performance with a low computational amount. This is a very important advantage in an environment such as a smart factory that requires fast and efficient data processing, enabling a maintenance robot to quickly monitor and respond to various conditions in the factory. As a result, the smart factory operating efficiency can be improved, and the accuracy and speed of maintenance work can be increased.

Although the embodiments of the present disclosure have been described in detail above, the scope of the present disclosure is not limited thereto, and various modifications and improvements made by those having ordinary knowledge in the art to which the present disclosure pertains using the basic concept of the present disclosure defined in the following claims also fall within the scope of the present disclosure.

What is claimed is:

1. A gauge reading method for reading an analog gauge through a maintenance robot, the gauge reading method comprising:
acquiring a first image including an environment including a gauge;
extracting a second image from the first image using an object detector, the second image corresponding to at least a partial portion of the first image and including the gauge;
inferring a zero point, a gauge end point, a needle center point, and a needle end point from the second image using a deep neural network;
obtaining a converted needle end point so that a depth difference between a gauge plate and a needle of the gauge is eliminated by reprojecting a location of the needle end point;
determining an angle formed by a scale start point or a scale end point, the needle center point, and the converted needle end point; and
converting the angle into a gauge value.

2. The gauge reading method of claim 1,
wherein two or more markers are disposed around the gauge in the first image, and
wherein the extracting of the second image includes:
extracting the second image from the first image, the second image corresponding to at least a partial portion of the first image and including the gauge and the two or more markers.

3. The gauge reading method of claim 2, wherein each of the two or more markers has a square shape, and includes a binary pattern including black and white colors.

4. The gauge reading method of claim 2, wherein the obtaining of the converted needle end point includes:
determining a camera intrinsic matrix;
determining a camera extrinsic matrix based on the camera intrinsic matrix; and
performing three-dimension point reconstruction based on the camera extrinsic matrix.

5. The gauge reading method of claim 4, wherein the determining of the camera intrinsic matrix includes:
determining the camera intrinsic matrix by estimating camera intrinsic parameters through camera calibration.

6. The gauge reading method of claim 4, wherein the determining of the camera extrinsic matrix includes:
obtaining real coordinates in a three-dimensional space for vertices of the two or more markers disposed around the gauge;
obtaining projection coordinates on a projection image for the vertices of the two or more markers; and
determining the camera extrinsic matrix using the real coordinates, the projection coordinates, and the camera intrinsic matrix.

7. The gauge reading method of claim 6, wherein the performing of the three-dimension point reconstruction includes:
obtaining the camera extrinsic matrix, an estimated location of the needle of the gauge on the projection image, and a real distance from the gauge plate to the needle;
obtaining an inverse function of a projection matrix;
obtaining three-dimensional coordinates of the needle by inputting the estimated location of the needle into the projection matrix; and
obtaining final coordinates by adjusting the obtained three-dimensional coordinates of the needle.

8. The gauge reading method of claim 1, further comprising:
defining a vertical line extending perpendicular to a horizontal side of the second image while passing through the needle center point;
determining a relative positional relationship by comparing coordinates of the needle center point and the needle end point in the second image;
determining a first angle formed by a first intersection point where the vertical line intersects a lower horizontal side of the second image, the needle center point, and the needle end point when it is determined that the needle end point is located to the left of the needle center point; and
converting the first angle into the gauge value.

9. The gauge reading method of claim 8, further comprising:
determining a second angle formed by a second intersection point where the vertical line intersects an upper horizontal side of the second image, the needle center point, and the needle end point when it is determined that the needle end point is located to the right of the needle center point; and
converting the second angle into the gauge value.

10. A gauge reading method for reading an analog gauge through a maintenance robot, the gauge reading method comprising:
acquiring a first image including an environment including a gauge;
extracting a second image from the first image using an object detector, the second image corresponding to at least a partial portion of the first image and including the gauge;
inferring a zero point, a gauge end point, a needle center point, and a needle end point from the second image using a deep neural network;
reading an operation mode set in the maintenance robot;
when the operation mode is set to a first operation mode, obtaining a converted needle end point so that a depth difference between a gauge plate and a needle of the gauge is eliminated by reprojecting a location of the needle end point, and determining an angle based on the converted needle end point;
when the operation mode is set to a second operation mode, determining an angle based on a vertical line defined to extend perpendicular to a horizontal side of the second image while passing through the needle center point when the operation mode is set to the second operation mode; and
converting the angle into a gauge value.

11. The gauge reading method of claim 10, further comprising:
evaluating a quality of the second image;
setting the operation mode to the first operation mode based on that the quality of the second image is evaluated to be higher than or equal to a predetermined criterion; and
setting the operation mode to the second operation mode based on that the quality of the second image is evaluated to be lower than the predetermined criterion.

12. The gauge reading method of claim 10, wherein the determining of the angle based on the converted needle end point includes:
determining an angle formed by a scale start point or a scale end point, the needle center point, and the converted needle end point.

13. The gauge reading method of claim 12, wherein the determining of the angle based on the converted needle end point includes:
determining a camera intrinsic matrix;
determining a camera extrinsic matrix based on the camera intrinsic matrix; and
performing three-dimension point reconstruction based on the camera extrinsic matrix.

14. The gauge reading method of claim 10, wherein the determining of the angle based on the vertical line includes:
determining a relative positional relationship by comparing coordinates of the needle center point and the needle end point in the second image; and
determining, as the angle, a first angle formed by a first intersection point where the vertical line intersects a lower horizontal side of the second image, the needle center point, and the needle end point when it is determined that the needle end point is located to the left of the needle center point.

15. The gauge reading method of claim 14, wherein the determining of the angle based on the vertical line includes:
determining, as the angle, a second angle formed by a second intersection point where the vertical line intersects an upper horizontal side of the second image, the needle center point, and the needle end point when it is determined that the needle end point is located to the right of the needle center point.

16. A gauge reading device for reading an analog gauge through a maintenance robot, the device comprising:
one or more memory devices configured to store instructions; and
one or more processors configured to execute the instructions to perform operations, the operations comprising:
acquiring a first image including an environment including a gauge;
extracting a second image from the first image using an object detector, the second image corresponding to at least a partial portion of the first image and including the gauge;
inferring a zero point, a gauge end point, a needle center point, and a needle end point from the second image using a deep neural network;
obtaining a converted needle end point so that a depth difference between a gauge plate and a needle of the gauge is eliminated by reprojecting a location of the needle end point;
determining an angle formed by a scale start point or a scale end point, the needle center point, and the converted needle end point; and
converting the angle into a gauge value.

17. The gauge reading device of claim 16,
wherein two or more markers are disposed around the gauge in the first image, and
wherein the extracting of the second image includes:
extracting the second image from the first image, the second image corresponding to at least a partial portion of the first image and including the gauge and the two or more markers.

18. The gauge reading device of claim 16, wherein the obtaining of the converted needle end point includes:
determining a camera intrinsic matrix;
determining a camera extrinsic matrix based on the camera intrinsic matrix; and
performing three-dimension point reconstruction based on the camera extrinsic matrix.

19. The gauge reading device of claim 16, wherein the operations further comprising:
defining a vertical line extending perpendicular to a horizontal side of the second image while passing through the needle center point;
determining a relative positional relationship by comparing coordinates of the needle center point and the needle end point in the second image;
determining a first angle formed by a first intersection point where the vertical line intersects a lower horizontal side of the second image, the needle center point, and the needle end point when it is determined that the needle end point is located to the left of the needle center point; and
converting the first angle into the gauge value.

20. The gauge reading device of claim 19, wherein the operations further comprising:
determining a second angle formed by a second intersection point where the vertical line intersects an upper horizontal side of the second image, the needle center point, and the needle end point when it is determined that the needle end point is located to the right of the needle center point; and
converting the second angle into the gauge value.
